(19) United States
(12) Patent Application Publication
(10) Pub. No.: US 2021/0221104 A1
(43) Pub. Date: Jul. 22, 2021

(54) LAMINATES AND METHODS WITH MULTIPLE INTERLAYERS AND MULTIPLE SUBSTRATES

(71) Applicants: Michael D. Broekhuis, Grand Rapids, MI (US); Harlan J. Byker, West Olive, MI (US); Jeffrey L. Lameris, Grand Haven, MI (US)

(72) Inventors: Michael D. Broekhuis, Grand Rapids, MI (US); Harlan J. Byker, West Olive, MI (US); Jeffrey L. Lameris, Grand Haven, MI (US)

(73) Assignee: Pleotint, L.L.C., West Olive, MI (US)

(21) Appl. No.: 17/223,581

(22) Filed: Apr. 6, 2021

Related U.S. Application Data
(62) Division of application No. 16/263,822, filed on Jan. 31, 2019.
(60) Provisional application No. 62/624,434, filed on Jan. 31, 2018.

(51) Int. Cl. B32B 17/10; B32B 7/14; B32B 37/10; B32B 38/00; B32B 37/00; C03C 27/10; F41H 5/04

(52) U.S. Cl. CPC B32B 17/10917; B32B 17/10302; B32B 7/14; B32B 37/1018; B32B 38/0036; B32B 2250/05; C03C 27/10; F41H 5/0407; B32B 2319/00; B32B 2309/68; B32B 37/0084

(57) ABSTRACT

Novel multilayer laminates and lamination methods useful for the production of safety glass are disclosed in which an interlayer is provided between substrates and a porous sealant material is provided in a strip around the perimeter of the interlayer and at least partially in-between the substrates adjacent the interlayer. The space between the substrates is evacuated or de-aired through the porous sealant. The porous sealant is then made into a non-porous, continuous perimeter seal by pressing at or near room temperature or at a moderately elevated temperature to remove pores or gaps. The laminate is further processed at higher elevated temperatures either at or near atmospheric pressure or at elevated pressure to increase the bonding between the interlayer and the substrates and to eliminate most or all of the initial texture on the surfaces of the interlayer.

### CROSS-REFERENCE TO RELATED APPLICATIONS

This application is a Division of U.S. patent application Ser. No. 16/263,822 filed Jan. 31, 2019, which claims the benefit of U.S. Provisional Patent Application No. 62/624,434, filed on Jan. 31, 2018, the contents of which are incorporated by reference in their entirety as part of this application.

### TECHNICAL FIELD

The present disclosure relates to the field of safety, impact and penetration resistant glazings, including multilayer laminates. Provided herein are durable, multilayer laminates and methods for making such laminates.

BACKGROUND

Laminates with multiple layers of glass and/or plastic are desirable for safety glass or safety laminates especially for use in impact, penetration, bullet and bomb blast resistant window or glazing units. These laminates may involve just two substrates of glass and/or plastic bonded together by an interlayer or they may involve as many as nine or ten substrates bonded together with eight or nine interlayers. When there are three substrates involved, a common lamination procedure involving a nip roll tack process followed by autoclave treatment is not easy to use and when there are more than three substrates the nip roll tack process is almost never used. With three or more substrates it is common to use a vacuum bagging technique with either re-useable or disposable vacuum bags.

In the vacuum bagging process, the laminate assembly is placed in the vacuum bag and the inside of the bag and the contents are evacuated or subjected to a reduced pressure. This immediately causes pressure to be applied to the laminate assembly when there is atmospheric pressure outside the bag and reduced pressure inside the bag. This pressure on the assembly makes the final deairing process time consuming or ineffective especially if edge seals between the substrates are used. After the vacuum is applied, the bag and the laminate assembly are normally heated with continued applied vacuum inside the bag to an elevated temperature between about 80 Celsius (° C.) and 160° C. in an oven, kiln or autoclave for at least several hours to allow the interlayer material to form a bond to the substrates and for any surface texture to disappear. An initial surface texture on the interlayers is desirable to help with the bulk of the removal of air from between the interlayers and the substrates. The final disappearance of texture happens by interlayer flowing into the vacuum space in the voids and/or by traces of gas dissolving into the interlayer. The pressure of a lamination type autoclave is particularly effective in promoting the flowing and/or dissolution processes. However, these lamination type autoclaves operating at elevated pressures and temperatures are more expensive to purchase and operate than ovens or kilns which generally operate at or near atmospheric pressure.

Vacuum bags used in the vacuum bagging process are typically loaded on horizontal trays which are then loaded into ovens, kilns or autoclaves with the tray support structure taking up valuable space. If vacuum bags were loaded on edge, the vacuum bag integrity would be at risk because of the weight exerted on the edge of the bag. Also, the substrates in vertically loaded bagged assemblies may slide/shift during heating. The present disclosure allows for edge loading to give better part nesting in ovens, kiln or autoclaves and thus higher throughput. The present disclosure also reduces edge distortion because there is no vacuum bag pinching of the edges of the laminates while they are heated.

For these and other reasons, the vacuum bagging process is problematic, slow, labor intensive, expensive, lower yield because bags occasional fail and the process is wasteful when disposable bags are involved. Thus, there is a need for multilayer laminates made by a low cost, high volume lamination method, procedure or process. There is also a desire for laminates with improved durability via higher quality edge sealants surrounding the interlayer of the laminate to prevent water, atmospheric moisture and environmental contaminates from entering the interlayer or the interface between the interlayer and the substrates which may cause problems including haze, bloom, bubbles, discoloration and/or delamination.

### SUMMARY

Multilayer laminates and lamination methods are provided in which interlayers are provided between substrates. A porous sealant material is provided in a strip around the perimeter of an interlayer and at least partially in-between the substrates adjacent the interlayer. The space between the substrates and the interlayer is evacuated or deaired through the porous sealant. The porous sealant is made into a non-porous, continuous perimeter seal(s) by pressing at or near room temperature or at a moderately elevated temperature to remove pores or gaps. The laminate is further processed at higher elevated temperatures either at or near atmospheric pressure or at elevated pressure to increase the bonding between the interlayer and the substrates and to eliminate most or all the initial texture on the surfaces of the interlayer. Novel laminates and novel methods of preparing the laminates are disclosed.

Provided herein is a laminate that may be largely transparent and clear, that includes at least 3 substrates, at least 2 interlayers and a perimeter seal around at least one of the interlayers wherein the perimeter seal is at least partially between the substrates and forms a continuous seal.

Also provided herein is a safety laminate that may be largely transparent and clear, that includes at least 4 substrates, at least 3 interlayers and a perimeter seal around at least one of the interlayers wherein the perimeter seal is at least partially between the substrates and forms a continuous seal around the interlayer.

Further provided herein is a laminate that may be largely transparent and clear, that includes at least 3 substrates, at least 2 interlayers and a perimeter seal around at least one of the interlayers wherein the perimeter seal is visible in the sight line of the laminate unit and forms a continuous seal around the interlayer.

Also provided herein is a laminate that may be largely transparent and clear, that includes at least 4 substrates, at least 3 interlayers and a perimeter seal around at least one of the interlayers wherein the perimeter seal is visible in the sight line of the laminate unit and forms a continuous seal around the interlayer.

Also provided herein is a lamination method including the following steps: preparing a laminate assembly by placing an interlayer on a first substrate, placing a porous sealant strip on the first substrate around the interlayer, placing a second substrate on the interlayer and porous sealant strip without compromising the porous nature of the sealant strip, evacuating the space between the substrates through the porous sealant strip, removing the porous nature of the sealant strip to form a continuous perimeter seal that is around the interlayer and at least partially between the substrates and heating the laminate assembly at, near or above atmospheric pressure to increase bonding between the interlayer and the substrates

Also provided herein is a lamination method including the following steps: preparing a laminate assembly by placing a first interlayer on a first substrate, placing a porous sealant strip on the first substrate around the first interlayer, placing a second substrate on the interlayer and porous sealant strip without compromising the porous nature of the sealant strip, placing a second interlayer on the second substrate, placing a porous sealant strip on the second substrate around the second interlayer, placing a third substrate on the second interlayer and porous sealant strip without compromising the porous nature of the sealant strip, evacuating the space between the substrates through the porous sealant strips, removing the porous nature of the sealant strips to form continuous perimeter seals that are around the interlayers and at least partially between the substrates, heating the laminate assembly at, near or above atmospheric pressure to increase bonding between the interlayers and the substrates. This lamination method may be extended to virtually any number of substrates and interlayers.

### DETAILED DESCRIPTION

The laminates described here involve substrate layers bonded together with interlayers. In addition to substrates and interlayers, the laminates of the present disclosure include an edge seal around the perimeter of one or more than one of the interlayers. The edge seal that is around the perimeter of one or more than one of the interlayers is at least partially between the substrates and the edge seal forms a continuous seal for the space between the substrates and the interlayer around the entire perimeter of the interlayer. That the edge seal is between the substrates means that the edge seal is visible in the sight line of the laminated glazing unit. The sight line is for the laminated glazing unit itself prior to installation into any type of frame. The use of the term “sight line” here is similar to its use in the window and window glass industry but for this disclosure the sight line is defined as outboard edge or perimeter of the largest substrate of the laminate and anything visible inside the very edge or perimeter of the laminate itself is within the sight line. In the present disclosure, the interlayers are normally slightly smaller in area than the substrates and the edge sealant materials are placed on the substrates adjacent to and preferably butted up against the interlayers. Preferably the interface between the interlayer and the edge seal forms the inboard edge of the edge seal encroachment into the sight line and the edge of the laminate forms the outboard edge of the sight line. The edge seal around the perimeter is formed at or near room temperature or at least below about 50 Celsius and is effective in minimizing or eliminating gas flow from the atmosphere into the space between the substrates for at least several hours. This edge seal is formed prior to further treatment like heating in an oven, kiln or autoclave.

The substrates are generally transparent although possibly tinted sheets of glass, printed glass, pattern glass, wire glass and/or plastic. The glass substrates may be float glass, drawn sheet, low iron glass, or soda lime glass with or without the addition of alumina to the glass composition. The glass may be annealed, heat strengthen, heat tempered or chemically toughened. The glass may also be untreated or thermally or chemically treated or strengthened borosilicate, alkali-boroaluminosilicate, boroaluminosilicate, aluminosilicate or alkali-aluminosilicate glass. The plastic substrates are typically sheets of polycarbonate, (PC), acrylics like polymethylmethacrylate, polyvinylchloride or poly(ethylene terephthalate), (PET), or amorphous poly(ethylene terephthalate), (APET), although other types of plastic substrates may be used. The substrates optionally have coatings which for example are transparent electronic conductors and/or reflect near infrared radiation. The thickness of the substrates has a wide range from as thin as 0.05 millimeter to as thick as 80 millimeters. Some type of glass is often used as the outer surface or substrate of the laminates for durability and ease of cleaning. However plastic substrates may be used on the outer surface or substrate of the laminate especially in cases where spall from impacted laminates is a concern. When plastics are used as the outer surfaces the plastic substrates are typically hard coated to increase scratch and abrasion resistance and provide ease of cleaning.

Each laminate generally contains one less interlayer than the number of substrates. Although, in some cases, the interlayer may comprise two or more polymer layers stacked between any pair of substrates to provide certain desirable impact resistant and acoustic properties. In this case the two or more layers between any pair of substrates may simply be referred to as the interlayer even if multiple interlayer sheets are provided. Preferably, these interlayers are independently selected from sheets or films of materials like for example silicone, elastomers like polyisobutylene or butyl rubber, polyvinylbutyral, (PVB), thermoplastic polyurethane, (TPU), thermoplastic polyolefins/polyolefin elastomers, (TPO/POE), ethylene vinyl acetate, (EVA), ethylene vinyl alcohol, (EVOH), ionomers like poly(ethylene-co-methacrylic acid) and ionomers including metal ions. The interlayers are generally transparent although possibly tinted or are printed on or have imbedded materials like wires. However, it is common that one or both of the surfaces of the interlayers are initially rough or textured to help with bulk deairing. During the lamination process the texture or surface roughness disappears or largely disappears so that in the finished laminate each interlayer is a transparent layer, wetted out and bonded to the substrates on either side of each interlayer and preferably the laminate, as a whole, apart from any intentional pattern or printing is nearly haze free or at least has a haze level between about 0.1% and about 4%.

The interlayers and/or substrates and thus the laminate may contain or possess polarizer, switchable, dynamic, thermochromic, photochromic and/or electrochromic properties. In particular, the laminate may include a polymer dispersed liquid crystal device with or without a polarizer layer or some other switchable technology, in which case the haze of the laminate may exceed 4%. The interlayers and/or substrates and thus the laminate may contain ultraviolet absorbing, near infrared absorbing, near infrared reflecting, fluorescent and/or phosphorescent materials or layers. The interlayers and/or substrates may have acoustic or sound deadening properties in addition to penetration and impact resistance.

The edge sealant material is selected from a material or mixture of materials or a combination of materials that will remain porous or provide gaps under the pressure or force of gravity acting on a laminate assembly made up of a stack of substrates and interlayers. The pores or gaps should remain open while the assembly is laid up and transported into a vacuum chamber and while the chamber and the assembly are evacuated. The vacuum chamber may be rigid or have dual chambers or have some other way of not applying force to the laminate assembly prior to deairing of the assembly. The edge sealant material should also allow the elimination of the porosity or gaps when pressure or force is applied to the assembly after the assembly is deaired or evacuated.

Preferable edge sealant material is an adhesive, adhesive coated strip, elastomer, plastic, rubber or polymer material or formulations, mixture or combination thereof that have some structural integrity but are deformable under modest applied pressure at or near room temperatures, for examples, from about 5° C. to about 50° C. One type of preferable edge sealant materials is elastomers with a low Young's Modulus and a high strain for failure. Preferable edge sealant materials have low gas permeability through the bulk of the material and form good bonds to substrates like glass and plastic sheets with low bulk and interfacial gas permeability. While many edge sealant materials may be used, preferable edge sealant materials include urethanes, epoxies, polyisobutylene, (PIB), polyisobutylene copolymers, butyl rubbers, silicones, contact adhesives and mixtures and combinations thereof. The edge sealant material(s) may contain plasticizers, tackifiers, fillers, stabilizers, rheology modifiers, coupling agents, adhesion promoters and/or crosslinking agents. The edge sealant may have fillers that make it colored like for example white, yellow, black or gray. The edge sealant may be translucent or clear and/or colorless. A preferred edge sealant material contains a silane coupling agent that promotes bonding between the substrate and the edge sealant material. An edge sealant strip may contain a mixture or a combination of materials that provide the structural integrity for holding the substrates apart or providing gaps to allow evacuation of the space between substrates and the interlayer(s). That the edge seal is between the substrates means that the edge seal is visible in the sight line of the laminated glazing unit which is anywhere inboard of the perimeter or edge of the substrates of the laminate. Even if the laminate is largely transparent and clear and the edge sealant is clear and/or colorless it will still be between the substrates and extend into the sight line. This is distinct from certain edge seal strips which are bonded around the perimeter of multilayer laminates during, for example, a vacuum bagging process but do not enter the sight line of the laminated glazing unit. Such edge seal strips are not considered part of the laminate itself with respect to the sight line defined herein.

Preferably the edge seal is between the substrate and impacts the sight line to an extent of from about 1 millimeter to about 40 millimeters. More preferably the edge seal is between the substrates and impacts the sight line to an extent of from about 2 millimeters to about 25 millimeters. If the laminate and the edge seal are largely clear and/or colorless, then the edge seal may only be noticeable on careful inspection even when it extends into the sight line by from about 1 millimeter to about 40 millimeters.

As used herein, the term “porous sealant strip” refers to a sealant strip that includes holes, openings, spaces, gaps, standoffs, foam-like porosity, pores, or a combination thereof. The porous nature of the edge sealant can provide more than 2 square millimeters (e.g. more than 10 square millimeters) of holes, openings, spaces, gaps, standoffs, foam-like porosity, pores, or a combination thereof in the edge sealant prior to exposure of the assembly to vacuum. The holes, gaps, indentations, openings, spaces, standoffs, pores, foam-like porosity or an overlap of strips provide space for air to readily escape from the laminate assembly. The edge sealant strip, which may comprise a porous sealant strip, will allow the openings, spaces, gaps, standoffs or pores to be flattened or closed off or eliminated when pressure or a force is applied after evacuation or deairing. The force may be applied, for example, by a platen that is brought into contact with the laminate assembly and pressed out by, for example, hydraulic or pneumatic force while the assembly is still in the vacuum chamber. Alternately a flexible membrane or sheet in the vacuum chamber that is held above or below the assembly during the evacuation process is then allowed to apply pressure and force after the evacuation process but while the assembly is still under vacuum. Preferably the elimination of the openings, spaces, gaps, standoffs or pores takes place at or near room temperature.

The pressure in the vacuum chamber during evacuation is preferably below about 15 torr and more preferably below about 1 torr. The time for evacuation is preferably between about 0.5 and about 30 minutes and more preferably between about 0.5 and about 20 minutes. The pressure applied to the assembly after evacuation to remove the porosity of the edge sealant strip and form a low permeability edge seal is preferably in the about 400 to about 9000 torr range.

The present disclosure provides a lamination method or process or procedure in which an interlayer is provided between each two adjacent substrates to form a laminate assembly. Multiple substrates and interlayers may be stacked to form a laminate assembly. For at least one of the interlayer layers, a porous sealant material is provided in a strip around the perimeter of the interlayer with the sealant material being provided at least partially between the pair of substrates. Without increased external force or pressure applied to the laminate assembly and without substantially raising the temperature of the laminate assembly, a vacuum is formed in the space between substrates and each interlayer surrounded by a porous edge sealant. The porous sealant material or strip(s) are then made into a non-porous, continuous perimeter seals by subsequent pressing in the vacuum chamber to remove pores or gaps. The laminate assembly is removed from the vacuum chamber through a load lock or by bringing the chamber back to atmospheric pressure. The laminate assembly is then further processed by heating the assembly at elevated temperatures either at or near atmospheric pressure or at elevated pressure. It is heated to increase the bonding between the interlayers and substrates and to eliminate most or all the initial texture or roughness on the surfaces of the interlayers.

Vacuum lamination chambers sometimes referred to as vacuum pressure laminators have been developed for relatively thin laminates. Normally the laminate assembly is heated through in the vacuum lamination chamber and the lamination process is finished while the unit is in the vacuum chamber. Or the interlayer itself seals off around the perimeter and the laminate is finished in a “curing” oven or kiln. While this happens in a reasonable amount of time with thin laminates it is too slow with thick laminate assemblies or is ineffective or gives poor yields. Vacuum lamination chambers are expensive, and throughput needs to be high to minimize cost. The methods of the present disclosure avoid the need to uniformly heat the laminate assembly or the entire laminate assembly in a vacuum lamination chamber to affect or finish the lamination process or at least self-seal all the interlayers in the vacuum lamination chamber. In a vacuum chamber this is difficult when there are three substrates involved and even more difficult with four or more substrates. Uniform or even adequate heating is difficult since heat is generally transferred from a heated bottom platen or in some cases from a heated bottom platen and a heated top platen. If the platens are made hotter to speed the heating the interlayers or substrates nearest the platens may be overheated. The substrates are normally thick and are poor thermal conductors and especially the center portion of the assembly takes a long time to heat up to a temperature effective to finish the lamination process. This is challenging for more than three substrates and more than two interlayers for substrates thicker than about 1 millimeter thick up to about 40 millimeters thick. This is even more challenging in the case of substrates thicker than about 2 millimeters thick up to about 80 millimeters thick. It is not uncommon for the final laminate stack or assembly of multiple substrates and interlayers to be 20 to 300 millimeters thick and heat transfer by conduction through this stack from, for example, heated platens on top and bottom may be on the order of several hours or more.

Poor heat transfer through the thick, multiple layers not only causes problems for the interlayer to uniformly bond to the substrates, the heat transfer is poor enough that any edge sealant materials present will not be easily heated. Thus, edge sealant materials and strips like adhesives, adhesive coated strips, elastomers and rubber sealants are preferred that can maintain openings, spaces, gaps, standoffs or pores that allow deairing or degassing between the substrates and interlayers. This structural integrity to maintain openings is needed even with large area, heavy stacks of substrates. However, the edge sealant materials should also be pressed out at or near room temperature or at least in the 5° C. to 50° C. temperature range to form a seal with low gas permeability that holds good vacuum. This seal should retain good vacuum or low gas permeation between the substrates for at least the several hours required for the completion of the lamination process or at least allow the lamination process to finish at or above atmospheric pressure without the formation of bubbles or areas where surface texture has not disappeared.

Since in a vacuum laminator chamber heating a thick stack and forming a good bond between interlayers and substrates and getting rid of surface texture on interlayers is particularly difficult in the middle of a stack of substrates and interlayers, it is possible to use the methods of the present disclosure for just one or more of the middle or near middle layer(s) of the stack. In this case a top and/or bottom of the multilayer laminate stack may optionally be a finished laminate. It may also be a pre-laminate that is formed by placing an interlayer between two substrates and passing the assembly through a conventional nip roll, platen press or vacuum tack process to self-seal the interlayer around the perimeter. The laminate or pre-laminate may be bonded to one or more than one additional substrate by providing an interlayer and a porous edge sealant strip on a laminate, pre-laminate or substrate and then placing a substrate, pre-laminate or laminate on the interlayer and porous edge sealant strip. The stack is then placed in a vacuum chamber and deaired through the porous edge sealant strip without applied pressure or force. The laminate structure is then pressed out to form a non-porous edge seal. This assembly is then removed from vacuum and finished in an oven, kiln or autoclave. An advantageous procedure involves the low-cost nip roll tacking of a pair of substrates with an interlayer to prepare a pre-laminate followed by placing an interlayer and porous edge sealant strip on one side of the pre-laminate followed by placing a substrate, another pre-laminate or a finished laminate on top and proceeding through the vacuum, pressing out of the porous edge sealant strip, removal from vacuum and then heating to an elevated temperature at, near or above atmospheric pressure procedure. Any number of laminates, pre-laminates and substrates may be stacked with intervening interlayers, in this way, to take advantage of making laminates and pre-laminates by conventional methods and then producing laminated stacks of the laminates and pre-laminates with optional additional substrates with the advantageous process of the present invention. Any combination of substrates, pre-laminates and laminates can be assembled and processed into a final multilayer laminated window or glazing unit by this novel procedure.

A numbering or designation scheme that is helpful in describing the laminates of the present disclosure is as follows. Starting from the bottom and going up through the stack as the assembly is laid up, the substrates and interlayers are numbered as substrate 1, interlayer 1, substrate 2, interlayer 2, substrate 3, interlayer 3 and substrate 4 which all together becomes a [4 substrate-3 interlayer] laminate. As a further illustration a [7 substrate-6 interlayer] laminate would be numbered from the bottom up in the assembly as substrate 1, interlayer 1, substrate 2, interlayer 2, substrate 3, interlayer 3, substrate 4, interlayer 4, substrate 5, interlayer 5, substrate 6, interlayer 6 and substrate 7. Once the laminate is finished, it would no longer have to be laying down with a particular substrate on the bottom and a particular one on top but original layup order could still be used no matter the orientation of the laminate. Although the laminate might need to be labeled to indicate for example which substrate is substrate 1 as the laminate will likely have a preferred orientation for installation with regard to for example the threat side versus the protection side of the laminate. In the present disclosure it would be possible for the edge seal that is at least partially between substrates and in the sight line to only be present around, for example, interlayer 4 or alternately, for example, around interlayers 3, 4 and 5 of a [7 substrate-6 interlayer] laminate.

The term “about” as used herein can allow for a degree of variability in a value or range, for example, within 10%, within 5%, or within 1% of a stated value or of a stated limit of a range.

In the methods of manufacturing described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The following non-limiting examples illustrate further the laminates and methods disclosed herein.

### EXAMPLES

### Example 1

For this example, the glass is annealed soda lime float glass and the TPU interlayer has an embossed texture on one side. The interlayers are placed on the substrates in a manner that will leave a uniform space around the perimeter of the substrates. The laminate is prepared as follows:
1. A 588 millimeter by 1188 millimeter film of TPU interlayer about 1.3 millimeters thick is laid on a 600 millimeter by 1200 millimeter sheet of glass about 9 millimeters thick;
2. A 5 millimeter wide and about 1.6 millimeter thick strip of PIB based sealant is laid on the glass around the TPU interlayer;
3. Indentations spanning the width of the sealant strip about 0.2 millimeter deep and about 1 millimeter wide are impressed into the sealant at about every 20 millimeters along the strip;
4. A 600 millimeter by 1200 millimeter sheet of glass about 6 millimeters thick is laid on top of the TPU interlayer and sealant strip without flattening out the indentations;
5. A 588 millimeter by 1188 millimeter film of TPU interlayer about 1.3 millimeters thick is laid on the 6 millimeter thick sheet of glass;
6. A 5 millimeter wide and about 1.6 millimeter thick strip of PIB based sealant is laid on the 6 millimeter thick glass around the TPU interlayer;
7. Indentations spanning the width of the sealant strip about 0.2 millimeter deep and about 1 millimeter wide are impressed into the sealant at about every 20 millimeters along the strip;
8. A 600 millimeter by 1200 millimeter sheet of polycarbonate about 9 millimeters thick is laid on top of the TPU interlayer and sealant strip without flattening out the indentations;
9. A 588 millimeter by 1188 millimeter film of TPU interlayer about 1.3 millimeters thick is laid on the polycarbonate sheet;
10. A 5 millimeter wide and about 1.6 millimeter thick strip of PIB based sealant is laid on the polycarbonate sheet around the TPU interlayer;
11. Indentations spanning the width of the sealant strip about 0.2 millimeter deep and about 1 millimeter wide are impressed into the sealant at about every 20 millimeters along the strip;
12. A 600 millimeter by 1200 millimeter sheet of glass about 6 millimeters thick is laid on top of the TPU interlayer and sealant strip without flattening out the indentations;
13. The assembly is then placed in a rigid vacuum chamber and the chamber is evacuated to a pressure of less than 1 torr at room temperature and held at this pressure for 10 minutes;
14. A platen in the vacuum chamber is then brought into contact with the assembly with a pressure of about 700 torr and the indentations in the PIB sealant strips are flattened and pressed out and disappeared to form continuous perimeter seals;
15. The platen pressure is removed and the assembly is removed from the chamber and placed in an oven at atmospheric pressure and then heated to 120° C. for 8 hours;
16. When the laminate was removed from the oven, it was clear with a haze level 1.7% and the interlayers were well bonded to the substrates.

The PIB based edge seals extend into the sight line of the laminate by about 6 mm around the perimeter and provide outstanding durability for the laminate by protecting the interlayer and the interfaces between the interlayers and the substrates from moisture, water and other environmental components.

### Example 2

For this example, the glass is annealed soda lime float glass and the TPU interlayer has an embossed texture on one side. The interlayer is placed on the substrate in a manner that leaves a uniform space around the perimeter of the substrate. The laminate is prepared as follows:
1. A 588 millimeter by 1188 millimeter film of TPU interlayer about 1.3 millimeters thick is laid on a 600 millimeter by 1200 millimeter sheet of glass about 9 millimeters thick;
2. Strips of butyl rubber sealant about 6 millimeter wide and about 1.35 millimeter thick are placed on the 9 millimeter thick glass all the way around the TPU interlayer. The strips are overlapped in all four corners to create standoffs or gaps in the sealant;
3. A 600 millimeter by 1200 millimeter sheet of glass about 5 millimeters thick is laid on top of the TPU interlayer and sealant strip without pressing out the standoffs or gaps;
4. A 588 millimeter by 1188 millimeter film of TPU interlayer about 1.3 millimeters thick is laid on the 5 millimeter thick sheet of glass;
5. Strips of butyl rubber sealant about 6 millimeter wide and about 1.35 millimeter thick are placed on the 5 millimeter thick glass all the way around the TPU interlayer. The strips are overlapped in all four corners to create standoffs or gaps in the sealant;
6. A 600 millimeter by 1200 millimeter sheet of polycarbonate about 9 millimeters thick is laid on top of the TPU interlayer and sealant strip without pressing out the standoffs or gaps;
7. A 588 millimeter by 1188 millimeter film of TPU interlayer about 1.3 millimeters thick is laid on the polycarbonate sheet;
8. Strips of butyl rubber sealant about 6 millimeter wide and about 1.35 millimeter thick are placed on the polycarbonate all the way around the TPU interlayer. The strips are overlapped in all four corners to create standoffs or gaps in the sealant;
9. A 600 millimeter by 1200 millimeter sheet of glass about 6 millimeters thick is laid on top of the TPU interlayer and sealant strip without pressing out the standoffs or gaps;
10. The assembly is then placed in a rigid vacuum chamber and the chamber is evacuated to a pressure of less than 1 torr at room temperature and held at this pressure for 10 minutes;
11. A platen in the vacuum chamber is then brought into contact with the assembly with a pressure of about 750 torr and the corner overlaps of the sealant and the gaps are pressed out and the sealant strips form a continuous, gap-free seal around each interlayer and the vacuum is retained between the substrates during the subsequent steps;
12. The platen pressure is then removed and the assembly is removed from the chamber and placed in an oven at atmospheric pressure and then heated to 120° C. for 8 hours;
13. When the laminate was removed from the oven, it was clear with a haze level 1.6% and the interlayers were well bonded to the substrates.

The butyl rubber edge seals extend into the sight line of the laminate by about 6 mm around the perimeter and provide outstanding durability for the laminate by protecting the interlayer and the interfaces between the interlayers and the substrates from moisture, water, and other environmental components.

### Example 3

For this example, the glass, unless otherwise noted, is annealed soda lime float glass, the TPU interlayer has an embossed texture on one side, and the PVB has a melt fracture induced texture on both sides. The interlayer is placed on the substrate in a manner that leaves a uniform space around the perimeter of the substrate. The laminate is prepared as follows:
1. A 600 millimeter by 1200 millimeter film of PVB interlayer about 1.5 millimeters thick is laid on a 600 millimeter by 1200 millimeter sheet of low iron glass about 6 millimeters thick;
2. A 600 millimeter by 1200 millimeter sheet of low iron glass about 6 millimeters thick is laid on top of the PVB interlayer;
3. This assembly is passed through a first heated nip roller, is heated in a conveyorized tunnel oven and is passed through a second heated nip roller to form a pre-laminate with self-sealed PVB near the perimeter;
4. A 588 millimeter by 1188 millimeter film of TPU interlayer about 1.3 millimeters thick is laid on the top glass of the pre-laminate;
5. A 5 millimeter wide and about 1.6 millimeter thick strip of PIB based sealant is laid on the top glass of the pre-laminate around the TPU interlayer;
6. Indentations that spanned the width of the sealant about 0.2 millimeter deep and about 1 millimeter wide are impressed into the sealant at about every 20 millimeters along the strip;
7. A 600 millimeter by 1200 millimeter sheet of acrylic about 9 millimeters thick is laid on top of the TPU interlayer and sealant strip without flattening out the indentations;
8. A 588 millimeter by 1188 millimeter film of TPU interlayer about 2 millimeters thick is laid on the top of the acrylic sheet;
9. A 5 millimeter wide and about 2.4 millimeter thick strip of PIB based sealant is laid on the acrylic sheet around the TPU interlayer;
10. Indentations that spanned the width of the sealant about 0.3 millimeters deep and about 1 millimeter wide are impressed into the sealant at about every 25 millimeters along the strip;
11. A 600 millimeter by 1200 millimeter sheet of glass about 6 millimeters thick is laid on top of the TPU interlayer and sealant strip without flattening out the indentations;
12. The assembly is placed in a rigid vacuum chamber and the chamber is evacuated to a pressure of less than 0.5 torr at room temperature and is held at this pressure for 7 minutes;
13. A platen in the vacuum chamber is brought into contact with the assembly with a pressure of about 750 torr and the indentations in the PIB based sealant are flattened and pressed out to form continuous seals;
14. The platen pressure is removed and the assembly is removed from the chamber and placed in an autoclave. The pressure is raised to about 9000 torr while the assembly is heated to 140° C. for 4 hours. The autoclave is allowed to cool and vented back to atmospheric pressure;
15. When the laminate was removed from the autoclave, it was clear with a haze level of 1.2% and the interlayers were well bonded to the substrates.

The PIB based edge seals extend into the sight line of the laminate by about 6 mm around the perimeter and provide outstanding durability for portions of the laminate by protecting some of the interlayer and the interfaces between the interlayers and the substrates from moisture, water, and environmental components.

### Example 4

For this example, the glass is heat strengthened soda lime float glass, the TPU interlayer has an embossed texture on one side, and the PVB has a melt fracture induced texture on both sides. The interlayer is placed on the substrate in a manner that leaves a uniform space around the perimeter of the substrate. The laminate is prepared as follows:
1. A 600 millimeter by 1200 millimeter film of PVB interlayer about 1.5 millimeters thick is laid on a 600 millimeter by 1200 millimeter sheet of glass about 6 millimeters thick;
2. A 600 millimeter by 1200 millimeter sheet of glass about 6 millimeters thick is laid on top the PVB interlayer;
3. This assembly is passed through a first heated nip roller, is heated in a conveyorized tunnel oven, and is passed through a second heated nip roller to form a pre-laminate with self-sealed PVB near the perimeter;
4. A 588 millimeter by 1188 millimeter film of TPU interlayer about 2 millimeters thick is laid on the top glass of the pre-laminate;
5. A 5 millimeter wide and about 2.4 millimeter thick strip of silane coupling agent modified PIB based sealant is laid on the top glass of the pre-laminate around the TPU interlayer;
6. Strips of butyl rubber sealant about 6 millimeters long and 2 millimeters by 2 millimeters in cross-section are placed every 30 millimeters around along the PIB strip in a manner that the butyl rubber sealant strips bridge the width of the PIB strip and provide standoffs;
7. A 600 millimeter by 1200 millimeter sheet of polycarbonate about 9 millimeters thick is laid on top the TPU interlayer and composite sealant strip such that the standoffs provide gaps between the polycarbonate and the PIB sealant;
8. A 588 millimeter by 1188 millimeter film of TPU interlayer about 1.3 millimeters thick is laid on top of the polycarbonate;
9. A 5 millimeter wide and about 1.6 millimeter thick strip of silane coupling agent modified PIB based sealant is laid on the polycarbonate around the TPU interlayer;
10. Indentations spanning the width of the sealant about 0.2 millimeter deep and about 1 millimeter wide are impressed into the sealant at about every 20 millimeters along the strip;
11. A 600 millimeter by 1200 millimeter sheet of glass about 6 millimeters thick is laid on top of the TPU interlayer and sealant strip without flattening out the indentations;
12. The assembly is placed in a rigid vacuum chamber and the chamber is evacuated to a pressure of less than 0.3 torr at room temperature and held at this pressure for 6 minutes;
13. A platen in the vacuum chamber is brought into contact with the assembly with a pressure of about 770 torr and the butyl rubber standoffs and the indentations in the PIB sealant are pressed out and flattened so that continuous edge seals form around the interlayers and between the substrates;
14. The platen pressure is removed and the assembly is removed from the chamber and placed in an autoclave; the pressure is raised to about 8000 torr while the assembly is heated to 140° C. for 4 hours; the autoclave is allowed to cool and is vented back to atmospheric pressure;
15. When the laminate was removed from the autoclave, it was clear with a haze level of less than 2% and the interlayers were well bonded to the substrates.

The PIB based edge seal and the composite edge seal extend into the sight line of the laminate by about 6 mm around the perimeter and provide outstanding durability for portions of the laminate by protecting some of the interlayers and the interfaces between the interlayers and the substrates from moisture, water and other environmental components.

### Example 5

For this example, the glass is fully tempered soda lime float glass, the TPU interlayer has an embossed texture on one side and the ionomer has embossed texture on both sides. The interlayer is placed on the substrate in a manner that leaves a uniform space around the perimeter of the substrate. The laminate is prepared as follows:
1. A 588 millimeter by 1188 millimeter film of TPU interlayer about 1.3 millimeters thick is laid on a 600 millimeter by 1200 millimeter finished laminate of two sheets of 5 millimeter thick glass bonded together with a 1.5 millimeter thick PVB interlayer;
2. A 5 millimeter wide and about 1.6 millimeter thick strip of PIB based sealant is laid on the top glass of the finished laminate around the TPU interlayer;
3. Indentations that spanned the width of the sealant about 0.2 millimeter deep and about 1 millimeter wide are impressed into the sealant at about every 20 millimeters along the strip;
4. A 600 millimeter by 1200 millimeter sheet of polycarbonate about 9 millimeters thick is laid on top of the TPU interlayer and sealant strip without flattening out the indentations;
5. A 588 millimeter by 1188 millimeter film of TPU interlayer about 2 millimeters thick is laid on top of the polycarbonate;
6. A 5 millimeter wide and about 2.4 millimeter thick strip of PIB based sealant is laid on the polycarbonate around the TPU interlayer;
7. Indentation spanning the width of the sealant about 0.3 millimeters deep and about 1 millimeter wide are impressed into the sealant at about every 30 millimeters along the strip;
8. A 600 millimeter by 1200 millimeter finished laminate of two sheets of 6 millimeter thick glass bonded together with a 2.3 millimeter thick ionomer interlayer is laid on top of the TPU interlayer and sealant strip without flattening out the indentations;
9. The assembly is placed in a rigid vacuum chamber and the chamber is evacuated to a pressure of less than 1 torr at room temperature and held at this pressure for 20 minutes;
10. A platen in the vacuum chamber is brought into contact with the assembly with a pressure of about 800 torr and the indentations in the PIB based sealant are pressed out and disappeared and a continuous perimeter seal formed;
11. The platen pressure is removed and the assembly is removed from the chamber and placed in an oven at atmospheric pressure and then heated to 120° C. for 6 hours;
12. When the laminate was removed from the oven, it was clear with a haze level of less than 3% and the interlayers were well bonded to the substrates.

The PIB based edge seals extend into the sight line of the laminate by about 6 mm around the perimeter and provide outstanding durability for the laminate by protecting the TPU interlayers and the interfaces between the TPU interlayers and the substrates from moisture, water, and environmental components.

### Example 6

For this example, the glass is annealed soda lime float glass and the TPU interlayer has an embossed texture on both sides. The interlayer is placed on the substrate in a manner that leaves a uniform space around the perimeter of the substrate. The laminate is prepared as follows:
1.A 588 millimeter by 1188 millimeter film of TPU interlayer about 0.65 millimeters thick is laid on a 600 millimeter by 1200 millimeter sheet of glass about 12 millimeters thick;
2. A 5 millimeter wide and about 0.8 millimeter thick strip of PIB based sealant is laid on the glass around the TPU interlayer;
3. Indentations spanning the width of the sealant about 0.3 millimeters deep and about 1 millimeter wide are impressed into the sealant at about every 15 millimeters along the strip;
4. A 600 millimeter by 1200 millimeter sheet of glass about 6 millimeters thick is laid on top of the TPU interlayer and sealant strip without flattening out the indentations;
5. A 588 millimeter by 1188 millimeter film of TPU interlayer about 1.3 millimeters thick is laid on the 6 millimeter thick sheet of glass;
6. A 5 millimeter wide and about 1.6 millimeter thick strip of PIB based sealant is laid on the glass around the TPU interlayer;
7. Indentations spanning the width of the sealant about 0.2 millimeters deep and about 1 millimeter wide are impressed into the sealant at about every 20 millimeters along the strip;
8. A 600 millimeter by 1200 millimeter sheet of polycarbonate about 18 millimeters thick is laid on top the TPU interlayer and sealant strip without flattening out the indentations;
9. A 588 millimeter by 1188 millimeter film of TPU interlayer about 2 millimeters thick is laid on top of the polycarbonate;
10. A 5 millimeter wide and about 2.4 millimeter thick strip of PIB based sealant is laid on the polycarbonate around the TPU interlayer;
11. Indentation spanning the width of the sealant about 0.1 millimeters deep and about 1 millimeter wide are impressed into the sealant at about every 30 millimeters;
12. A 600 millimeter by 1200 millimeter sheet of glass about 1.6 millimeters thick is laid on top of the TPU interlayer and sealant strip without flattening out the indentations;
13. The assembly is placed in a rigid vacuum chamber with a silicone membrane spanning the area of the chamber and dividing the chamber into top and bottom sections; the assembly is placed in the bottom section below the membrane and the chamber is evacuated at the same rate in both sections, above and below the membrane to a pressure of less than 0.5 torr which is held for 8 minutes at room temperature;
14. The top section above the silicone membrane in the vacuum chamber is brought to atmospheric pressure and the membrane pressed against the assembly with a pressure of about 755 torr and the indentations in the PIB based sealant are pressed out or flattened to form continuous perimeter edge seals;
15. The bottom of the vacuum chamber is brought to atmospheric pressure, the assembly is removed from the chamber and the assembly is placed in an oven at atmospheric pressure and then heated to 120° C. for 8 hours;
16. When the laminate was removed from the oven, it was clear with a haze level of less than 2% and the interlayers were well bonded to the substrates.

The edge seals extend into the sight line of the laminate by about 6 mm around the perimeter and provide outstanding durability for the laminate by protecting the interlayer and the interfaces between the interlayers and the substrates from moisture, water, and environmental components.

### Example 7

For this example, the glass is annealed soda lime float glass, the TPU interlayer has an embossed texture on one side, and the EVA has an embossed texture on both sides. The interlayer is placed on the substrate in a manner that leaves a uniform space around the perimeter of the substrate. The laminate is prepared as follows:
1. A 588 millimeter by 1188 millimeter film of EVA interlayer about 2 millimeters thick is laid on a 600 millimeter by 1200 millimeter sheet of glass about 9 millimeters thick;
2. Strips of butyl rubber sealant about 6 millimeter wide and about 2.05 millimeter thick are placed on the 9 millimeter thick glass all the way around the EVA interlayer. The strips are overlapped in all four corners to create standoffs or gaps in the sealant;
3. A 600 millimeter by 1200 millimeter sheet of glass about 5 millimeters thick is laid on top of the EVA interlayer and sealant strip without pressing out the standoffs or gaps;
4. A 588 millimeter by 1188 millimeter film of TPU interlayer about 1.3 millimeters thick is laid on the 5 millimeter thick sheet of glass;
5. Strips of butyl rubber sealant about 6 millimeter wide and about 1.35 millimeter thick are placed on the 5 millimeter thick glass all the way around the TPU interlayer. The strips are overlapped in all four corners to create standoffs or gaps in the sealant;
6. A 600 millimeter by 1200 millimeter sheet of polycarbonate about 6 millimeters thick is laid on top the TPU interlayer and sealant strip without pressing out the standoffs or gaps;
7. A 588 millimeter by 1188 millimeter film of TPU interlayer about 1.3 millimeters thick is laid on the polycarbonate sheet;
8. Strips of butyl rubber sealant about 6 millimeter wide and about 1.35 millimeter thick are placed on the polycarbonate all the way around the TPU interlayer. The strips are overlapped in all four corners to create standoffs or gaps in the sealant;
9. A 600 millimeter by 1200 millimeter sheet of glass about 6 millimeters thick is laid on top the TPU interlayer and sealant strip without pressing out the standoffs or gaps;
10. A 588 millimeter by 1188 millimeter film of EVA interlayer about 2 millimeters thick is laid on the 6 millimeter thick sheet of glass;
11. Strips of butyl rubber sealant about 6 millimeter wide and about 2.05 millimeter thick are placed on the 6 millimeter thick glass all the way around the EVA interlayer. The strips are overlapped in all four corners to create standoffs or gaps in the sealant;
12. A 600 millimeter by 1200 millimeter sheet of polycarbonate about 9 millimeters thick is laid on top the EVA interlayer and sealant strip without pressing out the standoffs or gaps;
13. A 588 millimeter by 1188 millimeter film of TPU interlayer about 1.3 millimeters thick is laid on the polycarbonate sheet;
14. Strips of butyl rubber sealant about 6 millimeter wide and about 1.35 millimeter thick are placed on the polycarbonate all the way around the TPU interlayer. The strips are overlapped in all four corners to create standoffs or gaps in the sealant;
15. A 600 millimeter by 1200 millimeter sheet of glass about 4 millimeters thick is laid on top the TPU interlayer and sealant strip without pressing out the standoffs or gaps;
16. The assembly is placed in a rigid vacuum chamber and the chamber is evacuated to a pressure of less than 0.1 torr at room temperature and held at this pressure for 10 minutes;
17. A platen in the vacuum chamber is brought into contact with the assembly with a pressure of about 850 torr and the corner overlaps of the sealant strips and the gaps are pressed out and the sealant strips form a continuous, gap free seal around each interlayer and the vacuum between the substrates is retained during the subsequent steps;
18. The platen pressure is removed and the assembly is removed from the chamber and placed in an oven at atmospheric pressure and then heated to 120° C. for 8 hours;
19. When the laminate was removed from the oven, it was clear with a haze level 3.6% and the interlayers were well bonded to the substrates.

The [6 substrate-5 interlayer] laminate produced in this example possesses excellent impact and bullet resistance. The butyl rubber edge seals extend into the sight line of the laminate by about 6 mm around the perimeter and provide outstanding durability for the laminate by protecting the interlayer and the interfaces between the interlayers and the substrates from moisture, water, and other environmental components.

In one aspect, the invention is a laminate comprising at least 3 substrates, at least 2 interlayers, and a perimeter seal around at least one of the interlayers, wherein the perimeter seal is at least partially between the substrates and forms a continuous seal.

In another aspect, the invention is a safety laminate comprising at least 4 substrates, at least 3 interlayers, and a perimeter seal around at least one of the interlayers, wherein the perimeter seal is at least partially between the substrates and forms a continuous seal around the interlayer.

In another aspect, the invention is a laminate comprising at least 3 substrates, at least 2 interlayers, and a perimeter seal around at least one of the interlayers, wherein the perimeter seal is visible in the sight line of the laminate unit and forms a continuous seal around the interlayer.

In another aspect, the invention is a laminate comprising at least 4 substrates, at least 3 interlayers, and a perimeter seal around at least one of the interlayers, wherein the perimeter seal is visible in the sight line of the laminate unit and forms a continuous seal around the interlayer.

In another aspect, the invention is a laminate wherein the perimeter seal is formed from a porous sealant strip.

In another aspect, the invention is a laminate wherein the perimeter seal is formed from a butyl rubber or PIB based sealant.

In another aspect, the invention is a laminate wherein the edge seal is visible in the sight line to between about 1 and about 40 millimeters.

In another embodiment, the invention is a laminate wherein the edge seal is visible in the sight line to between about 2 and about 25 millimeters.

In another aspect, the invention is a lamination method for preparing a laminate assembly comprising placing an interlayer on a first substrate, placing a porous sealant strip on the first substrate around the interlayer, placing a second substrate on the interlayer and porous sealant strip, evacuating the gases from the space between the substrates through the porous sealant strip, removing the porous nature of the sealant strip to form a continuous perimeter seal that is around the interlayer and at least partially between the substrates, and heating the laminate assembly at, near or above atmospheric pressure to increase bonding between the interlayer and the substrates.

In another aspect, the invention is a lamination method for preparing a laminate assembly comprising placing a first interlayer on a first substrate, placing a porous sealant strip on the first substrate around the first interlayer, placing a second substrate on the interlayer and porous sealant strip without compromising the porous nature of the sealant strip, placing a second interlayer on the second substrate, placing a porous sealant strip on the second substrate around the second interlayer, placing a third substrate on the second interlayer and porous sealant strip, evacuating the gases from the space between the substrates through the porous sealant strips, removing the porous nature of the sealant strips to form continuous perimeter seals that are around the interlayers and at least partially between the substrates, and heating the laminate assembly at, near or above atmospheric pressure to increase bonding between the interlayers and the substrates.

In another aspect, the invention is a lamination method wherein the placing a substrate on the interlayer and the porous sealant strip is done without compromising the porous nature of the sealant strip.

In another aspect, the invention is a lamination method for preparing a laminate assembly comprising a stack of 3 or more substrates, an interlayer between each pair of substrates, a porous sealant strip around at least one of the interlayers, evacuating the gas from the space between two substrates through the porous sealant strip, removing the porous nature of the sealant strip to form a continuous perimeter seal around at least one of the interlayers and at least partially between at least one pair of substrates, and heating the laminate assembly at, near or above atmospheric pressure to increase bonding between the interlayers and the substrates.

What is claimed is:

1. A lamination method comprising:
preparing a laminate assembly comprising:
placing a porous sealant strip on a first substrate;
placing an interlayer on the first substrate;
placing a second substrate on the interlayer and porous sealant strip,
evacuating the gases from the space between the substrates through the porous sealant strip, and
removing the porous nature of the porous sealant strip to form a continuous perimeter seal that is around the interlayer and at least partially between the substrates; and
heating the laminate assembly at, near or above atmospheric pressure to increase bonding between the interlayer and the substrates.

2. The method of claim 1, wherein the step of placing a second substrate on the interlayer and the porous sealant strip is done without compromising the porous nature of the sealant strip.

3. The method of claim 1, wherein the step of placing an interlayer on the first substrate is performed before the step of placing a porous sealant strip on a first substrate.

4. The method of claim 3, wherein the step of placing a porous sealant strip on a first substrate comprises placing the porous sealant strip around the perimeter of the interlayer.

5. The method of claim 4, wherein the step of placing a porous sealant strip on a first substrate comprises placing the porous sealant strip on the first substrate inboard of the perimeter of the first substrate in the sight line of the laminate assembly.

6. The method of claim 1, wherein the porous sealant strip is formed from a butyl rubber or PIB based sealant.

7. The method of claim 1, wherein the perimeter seal is visible in the sight line of the laminate assembly to between about 1 and about 40 millimeters.

8. The method of claim 1, wherein the perimeter seal is visible in the sight line of the laminate assembly to between about 2 and about 25 millimeters.

9. The method of claim 1, wherein the step of removing the porous nature of the porous sealant strip comprises pressing at room temperature or at a moderately elevated temperature to remove pores or gaps.

10. A lamination method comprising:
preparing a laminate assembly comprising:
providing a first substrate, a second substrate, a first interlayer between the first and second substrates, and a first porous sealant strip at least partially between the first and second substrates and around the perimeter of the first interlayer;
evacuating the gases from the space between the first and second substrates through the first porous sealant strip;
removing the porous nature of the first porous sealant strip to form a continuous perimeter seal that is around the first interlayer and at least partially between the first and second substrates; and
heating the laminate assembly at, near or above atmospheric pressure to increase bonding between the interlayers and the substrates.

11. The method of claim 10, wherein the first porous sealant strip is formed from a butyl rubber or PIB based sealant.

12. The method of claim 10, wherein the step of removing the porous nature of the first porous sealant strip comprises pressing at room temperature or at a moderately elevated temperature to remove pores or gaps.

13. A lamination method comprising:
preparing a laminate assembly comprising:
a stack of 3 or more substrates,
an interlayer between each pair of substrates,
a porous sealant strip around at least one of the interlayers,
evacuating the gas from the space between two substrates through the porous sealant strip, and
removing the porous nature of the porous sealant strip to form a continuous perimeter seal that is around at least one of the interlayers and at least partially between at least one pair of substrates; and
heating the laminate assembly at, near or above atmospheric pressure to increase bonding between the interlayers and the substrates.

14. The method of claim 13, wherein the step of removing the porous nature of the porous sealant strip comprises pressing at room temperature or at a moderately elevated temperature to remove pores or gaps.
